(19) United States
(12) Patent Application Publication
(10) Pub. No.: US 2011/0297001 A1
(43) Pub. Date: Dec. 8, 2011

(54) WINE AERATOR

(76) Inventor: Gary K. DeJohn, Greeley, CO (US)

(21) Appl. No.: 12/793,803

(22) Filed: Jun. 4, 2010

(51) Int. Cl. C12G 1/00; C12H 1/00; B01D 35/02; B01F 3/04

(52) U.S. Cl. 99/277.2; 261/112.1; 210/151

(57) ABSTRACT

An aerator has a sphere, several rods that project upwardly from the sphere, and a filter that sits on the rods. The rods rest on the mouth of a vessel such as a wine glass with the sphere at or below the mouth. A liquid such as wine is poured through the filter and onto the sphere to filter and aerate the liquid before the liquid settles in the vessel.

### TECHNICAL FIELD

The present invention relates to apparatus for aerating liquid and, more particularly, to a device that filters and aerates a liquid such as wine as the liquid is poured into a wine glass or other vessel.

### BACKGROUND ART

The taste of many wines can be improved by aerating the wine or allowing the wine to “breathe”. Simply uncorking a wine bottle and allowing the bottle to sit for a period of time is an ineffective method of aerating wine because the surface area of the wine exposed to the air is very small.

Decanting is often used to aerate and remove sediment from wine. Decanting includes the steps of setting the wine bottle upright for a period of time to allow the sediment to settle, opening the bottle and carefully pouring the wine from the bottle into a wide mouthed vessel or decanter until the sediment begins to appear in the neck of the bottle, and allowing the wine to sit in the decanter for a period of time to aerate. Decanting is suitable for home use where the wine can be selected beforehand.

The time required to aerate wine by decanting may not be available as, for example, when wine is served at restaurants. Known mechanical devices that accelerate the aeration of wine include pumps that pump air directly into the wine, and a motorized apparatus that pours the wine back and forth between two vessels. U.S. Pat. No. 7,299,743 to Moore discloses a decanter with a mesh filter that sits across the mouth of the decanter, a depression in the filter, a sphere that sits in the depression, and a valve at the bottom of the decanter for dispensing the wine. In Moore, wine is poured over the sphere to aerate the wine and through the filter to filter sediment.

Other known aerators include channeled spheres that are sized to fit across the diverging or flaring mouth of a carafe or decanter. Another known aerator for use with a decanter includes a glass funnel, and a metal spiral that fits inside the funnel and has a ball at the lower end. The Sharper Image® currently sells an aerator that sits on top of a wine glass. Vinturi, Inc. currently sells aerators for pouring wine into a wine glass. The Sharper Image® and Vinturi, Inc. aerators appear to flow wine through a tube with side holes.

### DISCLOSURE OF THE INVENTION

An aerator has a rounded aerating portion, a suspension system having a plurality of diverging rods that project upwardly from the aerating portion and bars that connect the rods opposite the aerating portion, and a filter that sits on the rods above the aerating portion. The aerating portion is smaller than the mouth of a vessel such as a wine glass. The rods rest on the mouth of the vessel with the aerating portion at or below the mouth. Wine is poured from a bottle through the filter, over the aerating portion and into the vessel.

### BRIEF DESCRIPTION OF THE DRAWINGS

Details of this invention are described in connection with the accompanying drawings that bear similar reference numerals in which:

The FIGURE is a perspective view of a wine aerator embodying features of the present invention.

### DETAILED DESCRIPTION OF THE INVENTION

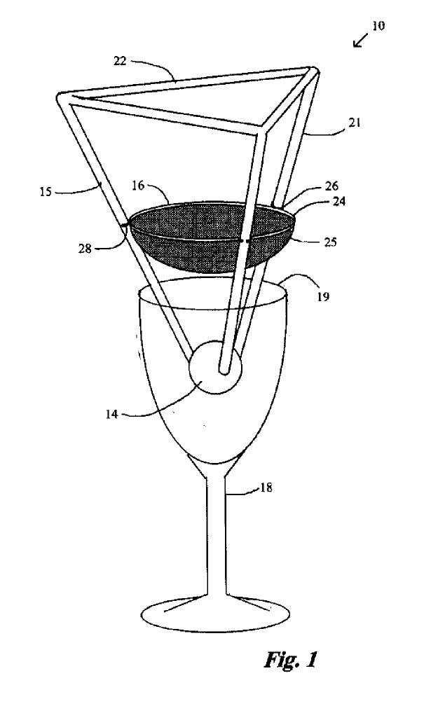

Referring now to FIG. 1, an aerator 10 embodying features of the present invention includes an aerating portion 14, a suspension system 15 and a filter 16. The aerator 10 is for use on a vessel 18 with an upwardly opening mouth 19, such as a wine glass. The aerating portion 14 has a three dimensional rounded shape. In the illustrated embodiment, the aerating portion 14 is a sphere. Alternatively, the aerating portion 14 could be spheroid shaped, oval or egg shaped, or another three dimensional rounded shape. The aerating portion 14 is sized smaller than the mouth 19 so as to be able to pass in spaced relationship through the mouth 19, into the vessel 18. The aerating portion shown is between about one inch and one and a half inches in diameter.

The suspension system 15 is connected to the aerating portion 14, and is sized and shaped to rest on the mouth 19 and suspend the aerating portion 14 in spaced relationship to the vessel 18 substantially below the mouth 19. The suspension system 15 is open, and allows liquid to flow over and around the aerating portion 14. The suspension system 15 includes a plurality of spaced rods 21 that project in different directions from the aerating portion 14. The suspension system 15 shown has three equally spaced, straight, cylindrical rods 21 that project from the aerating portion 14 in diverging directions, forming an inverted, triangular pyramid shape.

At least two rods 21 are needed to suspend the aerating portion 14 in the mouth 19 of the vessel 18, and more than three rods 21 can be used. If only two rods 21 are used, the rods 21 could project in opposite directions, but the two rods 21 would preferably project at a diverging angle to provide stability and to provide for support of the filter 16, described hereinafter. The rods 21 shown are straight and cylindrical. Alternatively, the rods 21 can be curved, can have other cross sectional shapes, and can have nonuniform cross sectional size, such as a taper. In the illustrated embodiment, the suspension system 15 includes a plurality of bars 22, with a bar 22 connecting the ends of each pair of rods 21 opposite the aerating portion 14.

The aerating portion 14 and suspension system 15 shown are made of glass. Alternatively, the aerating portion 14 and suspension system 15 could be made of plastic or metal, such as stainless steel. Preferably, the material used to make the aerating portion 14 and suspension system 15 is stain resistant.

The filter 16 includes a rim 24, a mesh portion 25 and a means 26 for releasably securing the filter 16 to the suspension system 15. The filter 16 is sized and shaped to be positioned on the suspension system 15 above the aerating portion 14. The rim 24 shown is circular. The mesh portion 25 connects across and around the rim 24, and is convex downwardly, extending downwardly and inwardly. The means 26 for releasably securing the filter 16 shown includes spring clips 28 that attach to the rim 24 and partially encircles each rod 21. Other fastening devices can be used for the means 26 for releasably securing the filter 16. The filter 16 is preferably made of stainless steel, but can be made of other materials.

The aerator 10 is placed onto the mouth 19 of a vessel 18, such as a wine glass. Wine from a bottle is poured onto the filter 16. The wine flows through the filter 16 and onto the aerating portion 14, while sediment is retained by the filter 16. The wine flows over the aerating portion 14 in a thin sheet with the aerating portion 14 exposing a large surface area of wine to the surrounding air and thereby aerating the wine. The aerator 10 can be used with vessels 18 other than wine glasses, such as decanters, carafes and other drinking glass types, and can be used to aerate liquids other than wine. The aerator 10 filters and aerates wine in 10 20 to 30 seconds, compared to the 20 to 30 minutes, or longer, required to filter and aerate wine with a conventional decanting method.

Although the present invention has been described with a certain degree of particularity, it is understood that the present disclosure has been made by way of example and that changes in details of structure may be made without departing from the spirit thereof.

What is claimed is:

1. An aerator for use with a vessel with an upwardly opening mouth, comprising:
an aerating portion having a rounded three dimensional surface and sized smaller than said mouth of said vessel so as to be able to pass in spaced relationship into said vessel, and
an open suspension system, connected to said aerating portion, and sized and shaped to rest on said mouth and suspend said aerating portion in spaced relationship to said vessel substantially below said mouth,
whereby a liquid that is being poured into said vessel is aerated by flowing over said aerating portion.

2. The aerator as set forth in claim 1 wherein said suspension system includes a plurality of spaced rods that project in different directions from said aerating portion,
whereby said rods rest on said mouth to suspend said aerating portion.

3. The aerator as set forth in claim 2 wherein said rods project in diverging directions,
whereby said rods suspend said aerating portion substantially below said mouth, and said suspension system fits different sizes of vessel.

4. The aerator as set forth in claim 3 wherein said suspension system has three equally spaced said rods substantially in the shape of an inverted, triangular pyramid.

5. The aerator as set forth in claim 4 wherein said suspension system includes a plurality of bars that connect said rods opposite said aerating portion.

6. The aerator as set forth in claim 2 wherein said rods have a cylindrical cross section.

7. The aerator as set forth in claim 2 wherein said rods are substantially straight.

8. The aerator as set forth in claim 1 including a filter that is sized and shaped to be positioned on said suspension system above said aerating portion,
whereby said filter filters solids from said liquid before said liquid is aerated.

9. The aerator as set forth in claim 8 wherein said filter has a mesh portion.

10. The aerator as set forth in claim 9 wherein said mesh portion is convex downwards.

11. The aerator as set forth in claim 9 wherein said mesh portion is made of stainless steel.

12. The aerator as set forth in claim 8 wherein said filter includes means for releasably securing said filter to said suspension system.

13. The aerator as set forth in claim 1 wherein said aerating portion is spherical.

14. The aerator as set forth in claim 13 wherein said aerating portion is between about one inch and one and a half inches in diameter.

15. The aerator as set forth in claim 1 wherein said aerating portion and said suspension system are glass.

16. An aerator for use with a vessel with an upwardly opening mouth, comprising:
a spherical aerating portion sized smaller than said mouth of said vessel so as to be able to pass in spaced relationship into said vessel, and
a suspension system having three equally spaced cylindrical rods that project upwardly from said aerating portion in diverging directions such that said rods rest on said mouth and suspend said aerating portion in spaced relationship to said vessel substantially below said mouth, and
a filter sized and shaped to be positioned on said rods above said aerating portion, said filter having a downwardly convex mesh portion and means for releasably securing said filter to said rods,
whereby wine that is being poured into said vessel is filtered by flowing through said filter and aerated by flowing over said aerating portion.
